(19) United States
(12) Patent Application Publication
(10) Pub. No.: US 2022/0039326 A1
(43) Pub. Date: Feb. 10, 2022

(54) METHOD FOR CONTROLLING BOX FOR CULTIVATING PLANTS, CULTIVATION BOX, AND DEVICE EMPLOYING METHOD

(71) Applicant: HONGFUJIN PRECISION ELECTRONICS(TIANJIN)CO.,LTD., Tianjin (CN)

(72) Inventors: CHIA-EN LI, New Taipei (TW); PO-HUI LU, New Taipei (TW)

(21) Appl. No.: 17/227,778

(22) Filed: Apr. 12, 2021

(30) Foreign Application Priority Data
Aug. 10, 2020 (CN) 202010797854.2

(51) Int. Cl. A01G 7/04; A01G 9/16

(52) U.S. Cl. CPC A01G 7/045; A01G 9/16

(57) ABSTRACT

A method of controlling a box for cultivating plants, to adapt the box environment to the current state of growth of the plant being cultivated. The brightness and wavelengths of the lighting, and other relevant conditions of the box, are controlled according to multiple sets of parameters for growth of such plants, at multiple stages. Images of the plant and information as to the actual illumination in the box are obtained from time to time. The method further analyzes a degree of change and thus growth of the plant based on the images. The method also supplies backup systems for the lighting and other types of service to the plant, to be activated when real-time calculations, based on the growth history of each plant and its current state, indicate accordingly parameter plant selected from the multiple sets of parameters. A plant cultivation system is also disclosed.

### FIELD

The subject matter herein generally relates to plant cultivation.

### BACKGROUND

Vegetables, fruits, and other plants are affected by conditions, such as light, temperature, humidity, and other factors. An artificial environment can be created in a plant factory, the plant factory may be divided into multiple cultivation areas, and each of the multiple cultivation areas may have a different environment. Personnel of the factory can transplant plants to different cultivation areas based on different growth stages of the plants. However, the creation of multiple cultivation areas requires high construction costs, and transplantation by personnel may be unreliable and inconvenient in non-laboratory surroundings.

Thus, there is room for improvement.

### BRIEF DESCRIPTION OF THE DRAWINGS

Implementations of the present disclosure will now be described, by way of embodiments, with reference to the attached figures.

FIG. 1 illustrates a plant being cultivated in an artificial environment system, in one embodiment.

FIG. 2 is a block diagram of an embodiment of a plant cultivation box and a computing device, applied in the system of FIG. 1.

FIG. 3 is a block diagram of another embodiment of a plant cultivation box, applied in the system of FIG. 1.

FIG. 4 is a block diagram of another embodiment of a computing device, applied in the system of FIG. 1.

FIG. 5 is a flow chart of an embodiment of a method of controlling the box for plant cultivation, applied in the system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

The term “comprising,” when utilized, means “including, but not necessarily limited to”; it specifically indicates open-ended inclusion or membership in the so-described combination, group, series, and the like.

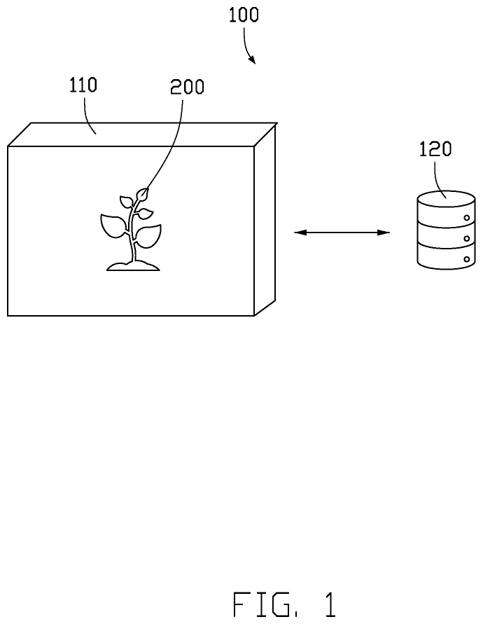

FIG. 1 illustrates a plant cultivation system 100, in one embodiment, for cultivating a plant 200. The plant cultivation system 100 can comprise a plant cultivation box 110 and a computing device 120. The plant cultivation box 110 provides an environment for cultivating the plant 200, the plant cultivation box 110 can communicate with the computing device 120.

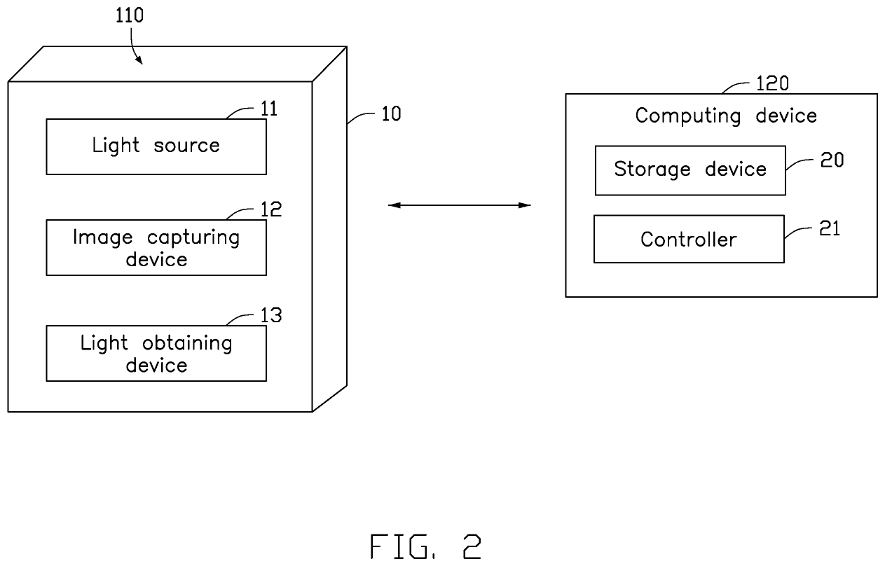

Referring to FIG. 2, the plant cultivation box 110 can comprise a box body 10, a light source 11, an image capturing device 12, and a light obtaining device 13. The box body 10 comprises a cultivation space for cultivating the plant 200. The light source 11 provides light for the plant 200, the image capturing device 12 can capture an image of the plant 200 at any stage during growth plant, and the light obtaining device 13 can gather information as to illumination in the cultivation space of the box body 10. The light source 11, the image capturing device 12, and the light obtaining device 13 can be arranged inside the box body 10.

In one embodiment, the image capturing device 12 can also be arranged outside the box body 10.

In one embodiment, the light source 11 can comprise one or more light emitting diodes (LEDs), and the LEDs can provide different intensities and different spectrums of light. The image capturing device 12 can comprise a camera, and the camera can capture images of the plant 200. The light obtaining device 13 can comprise an optical analyzer, the optical analyzer can obtain intensity of illumination and wavelengths of light in the cultivation space.

The computing device 120 can comprise a storage device 20 and a controller 21. The storage device 20 can store multiple sets of parameters for growth of plants. The plant 200 undergoes multiple stages of growth. The multiple sets of parameters correspond to growth conditions required by the plant 200 in these multiple stages. The controller 21 can detect the current growth stage of the plant 200 based on the images captured, and select a first parameter corresponding to the current stage of growth plant from the multiple sets of parameters. The controller 21 can control the light source 11 to output light of certain characteristics according to the first parameter.

In one embodiment, when the plant 200 is arranged into the box body 10 for the first time, the lighting state of the light source 11 can be controlled based on a predetermined parameter.

In one embodiment, in order to determine a growth state of the plant 200 and adjust the light source 11 accordingly, the controller 21 analyzes a degree of change and thus growth of the plant 200 based on the image. When the degree of change of the plant 200 within a first predetermined time meets a predetermined rule, the controller 21 determines that the plant 200 has entered a next growth stage and selects a second parameter matching with the next growth stage of the plant 200 from the multiple sets of parameters. The controller 21 can adjust the lighting state of the light source 11 according to the second parameter of the plant 200 and information as to the current illumination in the cultivation space.

In one embodiment, for each of the multiple growth stages of the plant 200, when the degree of change of the plant 200 within the first predetermined time meets the predetermined rule, the controller 21 determines that the plant 200 is entering the next growth stage. The first predetermined time can be set according to an actual application, for example, the first predetermined time can be 5 days.

In one embodiment, the computing device 120 can be a device with data processing functions such as a computer, a server, etc. The storage device 20 can comprise various types of non-transitory computer-readable storage mediums. For example, the storage device 20 can be an internal storage system, such as a flash memory, a random access memory (RAM) for the temporary storage of information, and/or a read-only memory (ROM) for permanent storage of information. The storage device 20 can also be an external storage system, such as a hard disk, a storage card, or a data storage medium. The storage device 20 can also be an SM card (Smart Media Card), an SD card (Secure Digital Card), or the like. The controller 21 can be a central processing unit (CPU), a microprocessor, a digital signal processor (DSP), an application specific integrated circuit (ASIC), a field-programmable gate array (FPGA), or other data processor chip.

In one embodiment, the computing device 120 can be a part of the plant cultivation box 110, such as a computing module installed therein.

In one embodiment, the plant 200 can be various types of plants, such as vegetables or fruits. In the box body 10, it is preferable to cultivate plants of the same or similar species. For example, the plant 200 can comprise four growth stages, such as a germination stage, a seedling stage, a flowering stage, and a fruiting stage. Each of the four growth stages can match with different parameters for growth. The parameters can comprise a combination of water information, nutrient information, temperature information, humidity information, illumination information, and light-wavelength information.

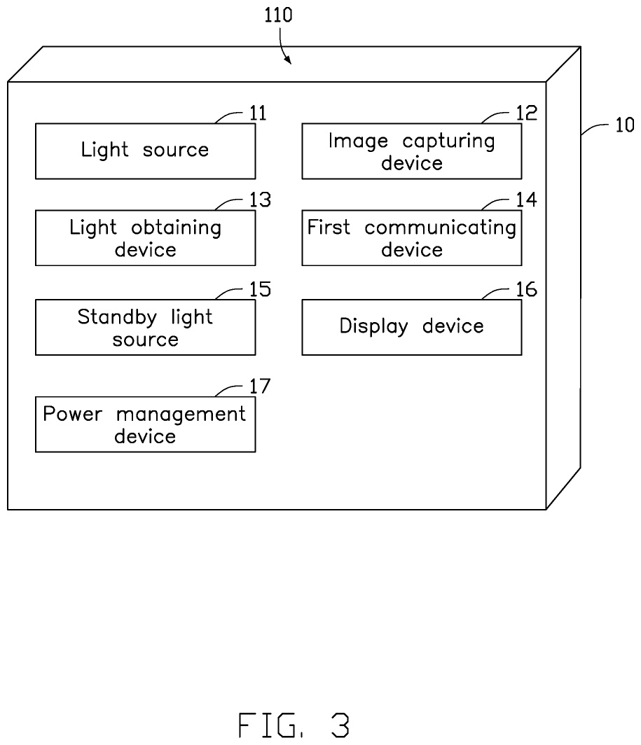

Referring to FIG. 3, the plant cultivation box 110 can comprise the box body 10, the light source 11, the image capturing device 12, the light obtaining device 13, a first communicating device 14, a standby light source 15, a display device 16, and a power management device 17. The image of the plant 200 captured by the image capturing device 12 and the illumination information in the cultivation space obtained by the light obtaining device 13 can be transmitted to the computing device 120 through the first communicating device 14.

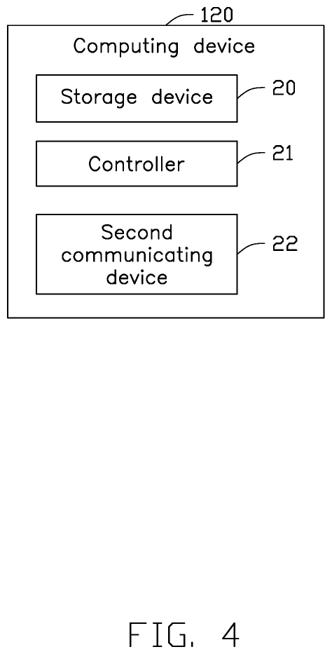

Referring to FIG. 4, in order to communicate with the plant cultivation box 110, the computing device 120 further comprises a second communicating device 22.

In one embodiment, the first communicating device 14 and the second communicating device 22 can be wireless communication modules or communication modules wired together, for example, a WI-FI unit, or a 5G wireless unit, etc. The standby light source 15 can comprise one or more LEDs. The display device 16 can comprise a display screen. The power management device 17 can comprise a power management chip.

In one embodiment, when the image capturing device 12 captures images of the plant 200 and the light obtaining device 13 obtains the illumination information in the cultivation space of the box body 10, the first communicating device 14 can periodically transmit to the computing device 120 an image showing growth and the illumination information.

For example, the first communicating device 14 transmits the image of the plant 200 and the illumination information in the cultivation space of the box body 10 to the computing device 120 at a second predetermined time interval. The second predetermined time interval can be less than the first predetermined time interval. The second predetermined time interval can be defined according to the actual application, for example, the second predetermined time can be 30 minutes. The first communicating device 14 transmits the image of the plant 200 and the illumination information in the cultivation space of the box body 10 to the computing device 120 at intervals of 30 minutes.

In one embodiment, the computing device 120 can use a predetermined growth algorithm to analyze the degree of change of the plant 200. The degree of change of the plant 200 comprises height change and/or size change of the plant 200. For example, the computing device 120 can analyze the degree of change of the plant 200 by comparing an image of the current growth stage of the plant 200 with the immediately-previous image of the plant 200, and determine whether the degree of change of the plant 200 after the first predetermined time interval meets the predetermined rule.

In one embodiment, the predetermined rule can comprise: a number of times that the degree of change of the plant 200 after each first predetermined time interval is determined to be a slow growth rate, the characterizations of growth states as being a “slow”, or “average”, or “rapid” growth state being calculated by reference to a certain predetermined value or range of values. The slow growth state comprises the degree of change of the plant 200 being not more than a predetermined degree of change. The predetermined degree of change can be defined according to the actual application. For example, the predetermined degree of change may be a change in height of 0.05 mm of the plant 200 or the predetermined degree of change might be a change in profile size of 0.5 mm² of the plant 200.

For each of the multiple growth stages of the plant 200, the number of times that a characterization of slow growth state is determined upon, is counted independently (for example, each of the multiple growth stages of the plant 200 is counted from 0). For example, in the germination stage of the plant 200, when the first number of times that the degree of change of the plant 200 in the first predetermined time interval is determined to be slow growth is at least equal to a first predetermined value, the controller 21 can determine that the plant 200 is entering the seedling stage. The first predetermined value can be defined according to the actual application, for example, the first predetermined value can be 5 times.

In one embodiment, the first communicating device 14 transmits the image of the plant 200 and the illumination information in the cultivation space to the computing device 120 at second predetermined time intervals. The predetermined growth algorithm can comprise the two formulas f1 and f2. Formula f1 can comprise: Growthᵢ=ΣHeightₘ/m, or Growthᵢ=ΣAreaₘ/m and formula f2 can comprise: Differenceᵢ=Growthᵢ−Growthᵢ₋₁.

In one embodiment, i and m can be natural numbers, i not being equal to m. Growthᵢ is the growth state of the plant 200 that is calculated based on the i-th data transmitted by the first communicating device 14, and Height is a sum of heights of the plant 200 based on m images comprised in the i-th data. Area is a sum of size or profile volumes of the plant 200 based on m images comprised in the i-th data, and Differenceᵢ is a degree of change of the plant 100 between the i-th data and the (i−1)-th data. When a value of Differenceᵢ is calculated, the controller 21 can determine whether the value of Differenceᵢ is less than the predetermined parameter of degree of change. If the value of Differenceᵢ is less than the predetermined degree of change, an increment of one is added to the number of times that the degree of change is determined to be the slow growth state.

In one embodiment, when the degree of change of the plant 200 within the first predetermined time interval meets the predetermined rule, the controller 21 determines that the plant 200 is entering the next growth stage. The controller 21 can use a predetermined progressive regulating algorithm to adjust the intensity of illumination and the wavelengths of light required by the current growth stage, for example to provide more or less UV light.

In one embodiment, the predetermined progressive regulating algorithm can comprise formulas f3 and f4 to adjust the ratios of wavelengths of light. Formula f3 can comprise: Spectrum_Difference=Spectrum_Next−Spectrum_Now+bias_1, and formula f4 can comprise: f(x)=Spectrum_Difference/Period*x+Spectrum_Now,

x={n|n∈N, 1≤n≤Period}.

In one embodiment, Spectrum_Difference is a different value of the ratio of wavelengths between the current time node and the next time node, Spectrum_Now is the ratio of wavelengths of the current time node, and Spectrum_Next is the ratio of wavelengths of the next time node. The Spectrum_Next can be predefined and stored in the storage device 20, bias_1 being a constant, and bias_1 being defined according to the actual application. Period is the number of cycles of the illumination information transmitted by the first communicating device 14. For example, when the plant 200 is placed into the box body 10 to start counting, and the computing device 120 receives the illumination information in the cultivation space eight times from the first communicating device 14, the value of Period can be 8.

In one embodiment, “n∈N” means that n is a natural number, and f(x) is the ratio of wavelengths that needs to be set in the x-th adjustment by the predetermined progressive regulating algorithm.

In one embodiment, the predetermined progressive regulating algorithm can comprise formulas f5 and f6, for adjusting the intensity of illumination. Formula f5 can comprise: Illuminance_Difference=Illuminance_Next−Illuminance_Now+bias_2, and formula f6 can comprise: g(x)=Illuminance_Difference/Period*x+Illuminance_Now, x={n|n∈N, 1≤n≤Period}.

In one embodiment, Illuminance_Difference is a value of difference of the intensity of illumination between the current time node and the next time node, Illuminance_Now is the intensity of illumination of the current time node, and Illuminance_Next is the intensity of illumination of the next time node. The Illuminance_Next can be predefined and stored in the storage device 20, bias_2 being a constant, and bias_2 being defined according to the actual application. g(x) is the intensity of illumination that needs to be set in the x-th adjustment by the predetermined progressive regulating algorithm.

In one embodiment, when the computing device 120 receives the illumination information from the first communicating module 14, the controller 21 can analyze the intensity of illumination and the ratio of wavelengths by using the predetermined progressive regulating algorithm to determine whether the current illumination in the cultivation space is abnormal. When the controller 21 determines that the intensity of illumination and/or the ratio of wavelengths in the cultivation space is abnormal, the controller 21 can control the standby light source 15 to turn on, and the actual illumination in the cultivation space can be adjusted to match with the current growth stage of the plant 200.

For example, the controller 21 can determine whether a ratio of the current intensity of illumination to the last intensity of illumination (first proportion) is a predetermined proportion. If the first proportion is not equal to the predetermined proportion, the controller 21 can determine that the intensity of illumination is abnormal, and an increment of one can be added to the counted number of abnormal intensities of illumination. When the number of abnormal illumination intensities is greater than a second predetermined value, the controller 21 controls the standby light source 15 to turn on. The controller 21 can also determine whether the current ratio of wavelengths of light within the cultivation space is equal to a certain ratio or within a predetermined ratio range. If the current ratio of wavelengths in the cultivation space is not the certain ratio or within the predetermined range, the controller 21 can determine that the ratio of wavelengths is abnormal, and an increment of one can be added to the number of times that the ratio of wavelengths is found to be abnormal. When the counted number of abnormal ratios of wavelength is found to be greater than a third predetermined value, the controller 21 controls the standby light source 15 to turn on.

In one embodiment, the second predetermined value and the third predetermined value can be defined according to the actual application. For example, the second predetermined value and the third predetermined value are both three, that is, occurring 3 times. For each of the multiple growth stages of the plant 200, the number of abnormal illumination intensities and the number of abnormal wavelength ratios are both counted from 0. For example, in each of the multiple growth stages of the plant 200, if the number of abnormal illumination intensities is more than 3 times or the number of abnormal wavelength ratios is more than 3 times, the controller 21 can determine that the current illumination in the cultivation space is abnormal, and control the standby light source 15 to turn on. The type of illumination in the cultivation space of the box body 10 can be adjusted to match with the current growth stage of the plant 200 after the standby light source 15 turned on.

In one embodiment, when the controller 21 controls the standby light source 15 to turn on, the controller 21 can further control the plant cultivation box 110 to output a warning, for example, the display device 16 can output the warning.

In one embodiment, the predetermined progressive regulating algorithm can comprise formulas f7 and f8. Formula f7 can comprise: Spectrumⱼ=(Wavelength_{q}+ . . . +Wavelengthₚ)/(p−q+1), and the formula f8 can comprise: R=Illuminance_{g}/Illuminance_{g-1}.

In one embodiment, g, j, p, and q can be natural numbers, j, p, and q being not equal to each other. Spectrumⱼ is the wavelength ratios in the cultivation space that is calculated based on the j-th data transmitted by the first communicating device 14. The light in the cultivation space of the box body 10 can be divided into monochromatic light q, monochromatic light q+1, monochromatic light q+2, monochromatic light q+3, . . . , and monochromatic light p. Wavelength_{q} is a wavelength of the monochromatic light q, Wavelengthₚ is a wavelength of the monochromatic light p.

When Spectrumⱼ is calculated, the controller 21 determines whether Spectrumⱼ is within the predetermined range of wavelength ratios. If Spectrumⱼ is outside the range, the number of abnormal ratios is incremented by one. Illuminance_{g} is the intensity of illumination in the cultivation space that is calculated based on the g-th data transmitted by the first communicating device 14. Illuminance_{g-1} is the intensity of illumination in the cultivation space that is calculated based on the (g−1)-th data transmitted by the first communicating device 14, and R is a ratio of the intensity of illumination of the g-th data to the (g−1)-th data. When a value of R is calculated, the controller 21 determines whether the value of R is equal to the first predetermined ratio, if the value of R is equal to the first predetermined ratio, the counted number of abnormal illumination intensities is incremented by one.

In one embodiment, the controller 21 controls the display device 16 to display the current growth stage and the current parameters of the plant 200. For example, the display device 16 displays the current level of water, the current levels or quantities of nutrients, the current temperature, the current humidity, and the intensity and spectrum of the current illumination.

In one embodiment, the plant cultivation box 110 can comprise a water providing unit to provide water for the plant 200, a nutrient providing unit to provide nutrients for the plant 200, a temperature configuration unit to provide a suitable temperature environment for the plant 200, a humidity configuration unit to provide a suitable humidity environment for the plant 200, a light unit (the light source 11 and the standby light source 15) to provide a suitable intensity of illumination and a suitable wavelengths of light for the plant 200.

In one embodiment, when a corresponding unit (a water providing unit, a nutrient providing unit, . . . , a light unit) needs to be enabled, the control module 21 controls the power management device 17 to provide power for the corresponding unit to save power.

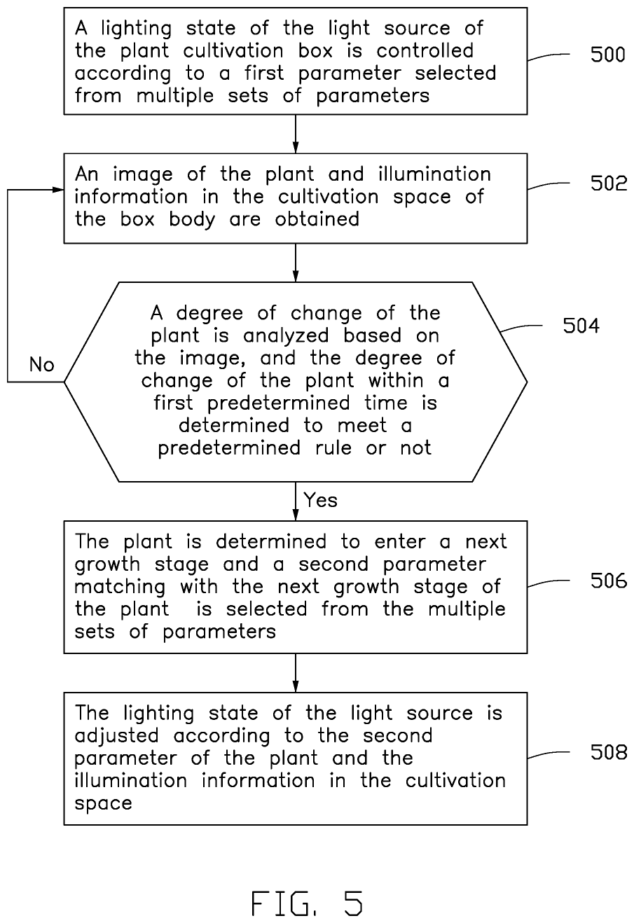

FIG. 5 illustrates one exemplary embodiment of a control method of the plant cultivation box 110. The flowchart presents an exemplary embodiment of the method. The exemplary method is provided by way of example, as there are a variety of ways to carry out the method. Each block shown in FIG. 5 may represent one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 500.

In block 500, a lighting state of the light source 11 of the plant cultivation box 110 is controlled according to a first parameter selected from multiple sets of parameters.

In one embodiment, the plant cultivation box 110 is configured to cultivate the plant 200, and the light source 11 is arranged inside the plant cultivation box 110. The plant 200 comprises multiple growth stages, the first parameter corresponds to the growth condition required by the plant 200 in the current growth stage.

In block 502, an image of the plant 200 and illumination information in the cultivation space of the box body 10 are obtained.

In one embodiment, the illumination information can comprise an intensity of illumination and wavelengths of light.

In block 504, a degree of change of the plant 200 is analyzed based on the image, and the degree of change of the plant 200 within a first predetermined time is determined to meet a predetermined rule or not.

In block 506, when the degree of change of the plant 200 within the first predetermined time meets the predetermined rule, the plant 200 is determined to enter a next growth stage and a second parameter matching with the next growth stage of the plant is selected from the multiple sets of parameters.

In one embodiment, when the degree of change of the plant 200 within the first predetermined time does not meet the predetermined rule, the method can return to block 502.

In block 508, the lighting state of the light source 11 is adjusted according to the second parameter of the plant 200 and the illumination information in the cultivation space.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A control method applicable in a plant cultivation box comprising a box body and a light source, the box body comprising a cultivation space configured for cultivating a type of plants, and the light source is arranged inside the box body, the control method comprising:
controlling a lighting state of the light source according to a first parameter selected from multiple sets of parameters, wherein multiple growth stages are defined according to the type of plants, the first parameter corresponds to a growth condition required by the type of plants in a current growth stage;
obtaining an image of a plant in the box body and illumination information in the cultivation space of the box body, wherein the illumination information comprises an intensity of illumination and wavelengths of light;
analyzing a degree of change of the plant based on the obtained image and determining whether the degree of change of the plant within a first predetermined time meets a predetermined rule;
determining that the plant is in a next growth stage and selecting a second parameter matching the next growth stage of the plant from the multiple sets of parameters when the degree of change of the plant within the first predetermined time is determined to meet the predetermined rule; and
adjusting the lighting state of the light source according to the second parameter of the plant and the illumination information in the cultivation space.

2. The control method of claim 1, wherein the predetermined rule comprises a first number of times that the degree of change of the plant in the first predetermined time is determined to be a slow growth state being equal to or greater than a first predetermined value, the slow growth state being the degree of change of the plant not more than a predetermined degree of change.

3. The control method of claim 1, further comprising:
obtaining images of the plant and the illumination information in the cultivation space of the box body at second predetermined time intervals;
wherein the second predetermined time is less than the first predetermined time.

4. The control method of claim 1, wherein the plant cultivation box further comprises a standby light source.

5. The control method of claim 4, further comprising:
counting a second number of times that the intensity of illumination of the cultivation space is abnormal and a third number of times that the wavelengths of light of the cultivation space is abnormal at each of the multiple growth stages of the plant;
determining whether the second number of times is greater than a second predetermined value and the third number of times is greater than a third predetermined value; and
enabling the standby light source when the second number of times is determined to be greater than the second predetermined value and/or the third number of times is determined to be greater than the third predetermined value.

6. The control method of claim 4, wherein when the standby light source is enabled, the illumination information in the cultivation space of the box body is changed to match the current growth stage of the plant.

7. The control method of claim 1, wherein the degree of change of the plant comprises a change in height and/or in size of the plant, each of the multiple sets of parameters comprises a combination of water information, nutrient information, temperature information, humidity information, illumination information, and spectrum information.

8. A plant cultivation system comprising:
a plant cultivation box comprising:
a box body comprising a cultivation space for cultivating a plant, wherein the plant comprises multiple growth stages;
a light source arranged inside the box body;
an image capturing device capturing an image of the plant; and
a light obtaining device obtaining illumination information in the cultivation space of the box body, wherein the illumination information comprises an intensity of illumination and wavelengths of light;
a computing device comprising:
a storage device storing multiple sets of parameters, wherein the multiple sets of parameters correspond to the growth conditions required by the plant in the multiple growth stages; and
a controller analyzing the current growth stage of the plant based on the image, selecting a first parameter corresponding to the current growth stage of the plant from the multiple sets of parameters, and controlling the lighting state of the light source according to the first parameter;
wherein the controller analyzes a degree of change of the plant based on the image;
when the degree of change of the plant within a first predetermined time meets a predetermined rule, the controller determines the plant to enter a next growth stage, and the controller selects a second parameter matching with the next growth stage of the plant from the multiple sets of parameters, and adjusts the lighting state of the light source according to the second parameter of the plant and the illumination information in the cultivation space.

9. The plant cultivation system of claim 8, wherein the plant cultivation box further comprises a communicating device, the communicating device transmits the image of the plant and the illumination information in the cultivation space of the box body to the computing device at second predetermined time intervals, the second predetermined time is less than the first predetermined time.

10. The plant cultivation system of claim 8, wherein the predetermined rule comprises a first number of times that the degree of change of the plant in the first predetermined time is determined to be a slow growth state being equal to or greater than a first predetermined value, and the slow growth state comprises the degree of change of the plant is not more than a predetermined degree of change.

11. The plant cultivation system of claim 8, wherein the plant cultivation box further comprises a standby light source.

12. The plant cultivation system of claim 11, wherein the controller counts a second number of times that the intensity of illumination of the cultivation space is abnormal and a third number of times that the wavelengths of light of the cultivation space is abnormal at each of the multiple growth stages of the plant, the controller further enables the standby light source when the second number of times is greater than a second predetermined value and/or the third number of times is greater than a third predetermined value.

13. The plant cultivation system of claim 11, wherein when the standby light source is enabled, the illumination information in the cultivation space of the box body is changed to match with the current growth stage of the plant.

14. The plant cultivation system of claim 8, wherein the degree of change of the plant comprises height change and/or size change of the plant, each of the multiple sets of parameters comprises a combination of water information, nutrient information, temperature information, humidity information, illumination information, and spectrum information.

15. The plant cultivation system of claim 14, wherein the plant cultivation box further comprises a display device, the computing device controls the display device to display the current growth stage and the current parameter of the plant.
